(19) United States
(12) Patent Application Publication
(10) Pub. No.: US 2023/0196378 A1
(43) Pub. Date: Jun. 22, 2023

(54) CARBON EMISSION BOUNDED MACHINE LEARNING

(71) Applicant: International Business Machines Corporation, Armonk, NY (US)

(72) Inventors: Prithwish Chakraborty, New York, NY (US); Mohamed Ghalwash, Yorktown Heights, NY (US); Daby Mousse Sow, Croton on Hudson, NY (US)

(21) Appl. No.: 17/557,089

(22) Filed: Dec. 21, 2021

(51) Int. Cl. G06Q 30/00; G06N 20/00

(52) U.S. Cl. CPC G06Q 30/018; G06N 20/00

(57) ABSTRACT

An approach for training a machine learning model within a carbon budgetary constraint may be provided. The approach may include receiving a carbon budget constraint, for training a machine learning model. The approach may also include generate a training plan for the machine learning model within the carbon budget constraint. Generating the training plan may include sampling the search space of the machine learning model and identifying hyperparameters that will have the greatest effect on the accuracy of the machine learning model. The approach may also include monitoring carbon emissions of the machine learning model training plan. Further, the approach may include updating the training plan of the machine learning model based on the monitored carbon emissions.

### BACKGROUND OF THE INVENTION

The present invention relates generally to machine learning, more specifically, to training of a machine learning model while bounded to a carbon emission budget.

Machine learning models have changed the nature of computing. Machine learning models receive inputs about the environment and make predictions based on the input. Training machine learning models is a resource heavy task. It typically requires multiple rounds of training where each round includes tuning thousands to millions of hyperparameters. Tuning each hyperparameter requires a multitude of calculations. The calculation heavy nature of training machine learning models is therefore, also computing resource heavy requiring immense processing power and memory/storage utilization. Furthermore, special computing resources have been developed to train these models more efficiently and quickly. However, these computing resources still require electricity immense amounts of electricity. While great strides have been made to switch electrical grids to renewable resources, carbon emitting power plants are still a large part of the overall power generation in many regions.

### SUMMARY

Embodiments of the present disclosure include a computer-implemented method, computer program product, and a system for carbon emission bounded training of machine learning models. Embodiments may include receiving a carbon budget constraint, for training a machine learning model. Embodiments may also include generating a training plan for the machine learning model within the carbon budget constraint. Embodiments may also include monitoring carbon emissions of the machine learning model training plan. Additionally, embodiments, may include updating the training plan of the machine learning model based on the monitored carbon emissions.

It should be understood, the above summary is not intended to describe each illustrated embodiment of every implementation of the present disclosure.

### BRIEF DESCRIPTION OF THE DRAWINGS

FIG. 1 is a functional block diagram generally depicting carbon bounded machine learning model training system 100, in accordance with an embodiment of the present invention.

FIG. 2 is a diagram generally depicting carbon tuner engine 110, in accordance with an embodiment of the present invention.

FIG. 3 is a flowchart depicting operational steps of a method for carbon bounded machine learning model training 300, in accordance with an embodiment of the present invention.

FIG. 4 is a functional block diagram of an exemplary computing system 10 within carbon bounded machine learning model training system 100, in accordance with an embodiment of the present invention.

FIG. 5 is a diagram depicting a cloud computing environment, in accordance with an embodiment of the present invention.

FIG. 6 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted and described herein recognize the benefits of carbon bounded training of machine learning models. Embodiments of the present invention may provide an end-to-end approach to allow the training of machine learning models to adhere to a pre-defined carbon budget, while maximizing exploration of the search space for optimal training within the constraints.

In an embodiment of the present invention, hyperparameter tuning of machine learning models can be carbon budget aware. For example, it may plan to distribute training runs over certain computing resources and efficiently sample the hyperparameter space to maximize exploration without exceeding a predefined carbon budget. In another example, the hyperparameter tuning can be set to a pre-determined performance within the carbon budget.

In an embodiment of the invention, a model can be customized to fine-tune a single aspect of the machine learning model architecture, allowing optimization of the model within the carbon budget. For example, specific connections between nodes within a deep neural network may have a greater effect on the model than another connections. The connections with the greater effect may be concentrated on, while the connections with less effect may be ignored, requiring less calculations. In another example, some layers within a deep neural network may be skipped entirely creating connections between nodes in different layers.

In an embodiment of the invention the power consumption of the computing system performing the hyperparameter tuning can be monitored. For example, depending on factors associated computing resource, the reporting may prevent a computing resource from performing specific tasks and reassign tasks to other computing resources that will consume less electricity provided by carbon emitting sources. For example, in an area where temperatures require a server bank to be cooled by air conditioning or where a server bank utilizes less efficient computing processors, training can be prevented in this area and the training can be reassigned to a region where temperatures are lower and where more power efficient computing resources may be utilized.

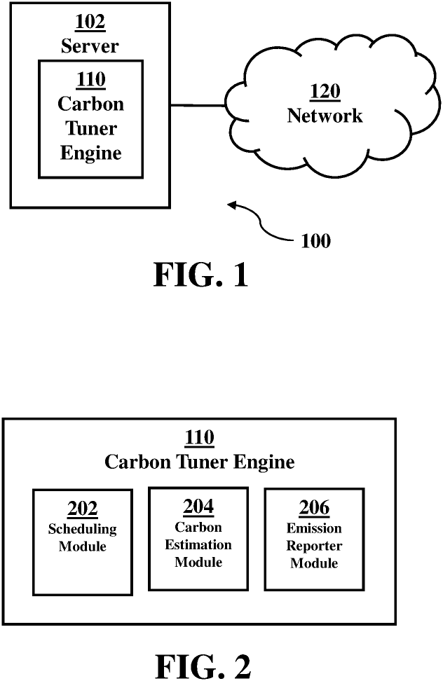

FIG. 1 is a functional block diagram depicting, generally, carbon bounded machine learning model training system 100. Shown in carbon bounded machine learning model training system 100 is server 102, and network 120. Operational on server 102 is carbon tuner engine 110.

Server 102 can be a standalone computing device, a management server, a web server, a mobile computing device, or any other electronic device or computing system capable of receiving, sending, and processing data. In other embodiments, server 102 can represent a server computing system utilizing multiple computers as a server system. It should be noted, while one server and one client computer are shown in FIG. 1, carbon bounded machine learning model training system 100 can have any number of servers. In another embodiment, server 102 can be a laptop computer, a tablet computer, a netbook computer, a personal computer, a desktop computer, or any programmable electronic device capable of communicating with other computing devices (not shown) within carbon bounded machine learning model training system 100 via network 120.

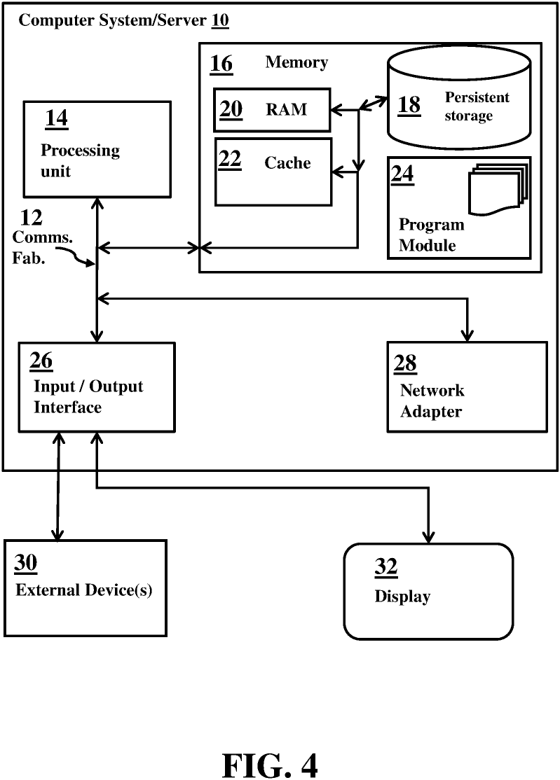

In another embodiment, server 102 represents a computing system utilizing clustered computers and components (e.g., database server computers, application server computers, etc.) that can act as a single pool of seamless resources when accessed within carbon bounded machine learning model training system 100. Server 102 can include internal and external hardware components, as depicted, and described in further detail with respect to FIG. 4.

Operational on server 102 is carbon tuner engine 110. Carbon tuner engine 110 is a computer program that can be configured to train a machine learning model to adhere to a predefined carbon budget, while maximizing the exploration of the search space. In an embodiment of the invention, carbon tuner engine 110 can receive carbon emission budget constraints, schedule time, location, and type of training for a machine learning model, plan the hyperparameter training of a machine learning model, track the actual carbon footprint of a machine learning model during training, and predict the carbon use of future iterations or rounds of training a machine learning model.

In an embodiment, carbon tuner engine 110 can be a cloud native assembly. For example, the cloud assembly can be a hybrid cloud cluster as a docker image. The carbon tuner engine 110 can be installed as a full stack, accessible and usable among multiple operating systems and different computing architectures, with a user interface that allows for seamless user input of the type of machine learning model, including hyperparameter space and the carbon budgetary constraints. Additionally, carbon tuner engine 110 can allow for modes where users can specify acceptable performance metrics (e.g., model accuracy, monetary cost, training time, epochs, etc...) and optimize for carbon emissions. In general, carbon tuner engine 110 can provide an end-to-end, readily usable program allowing training of a machine learning model within a pre-defined carbon budget while maximizing exploration of the models’ hyperparameter search space.

Network 120 can be, for example, a local area network (LAN), a wide area network (WAN) such as the Internet, or a combination of the two, and can include wired, wireless, or fiber optic connections. In general, network 120 can be any combination of connections and protocols that will support communications between server 102, and other computing devices within carbon bounded machine learning model training system 100.

FIG. 2 is a diagram generally depicting carbon tuner engine 110, in accordance with an embodiment of the present invention. Shown operational on carbon tuner engine 110 is scheduling module 202, carbon estimation module 204, and emissions reporter module 206.

Scheduling module 202 is a computer module that can schedule the training of a machine learning model within the constraints of a carbon budget. In an embodiment, scheduling module 202 can receive a carbon budget from a user or use a pre-existing carbon budget used for similar machine learning models. For example, scheduling module 202 can receive a budget of a zero carbon footprint. Scheduling module 202 can arrange the training of the machine learning model in a region that relies solely on renewable resources such as wind, solar, or hydroelectric power. It should be noted, scheduling module 202 can dynamically adjust the plans associated with training of a machine learning model in response to new developments, such as weather, availability of new more efficient hardware, and local utilization of different non-carbon energy sources.

In another embodiment, scheduling module 202 can operate as a global scheduler, which identifies the set of nodes with enough resources of the type requested by the training task and of the identified node, and selects the nodes with the lowest estimated wait time. For example, scheduling module 202 can operate as a Ray scheduler with an application layer and a system layer, where resource heterogenous (e.g., GPU type, DRAM, type, CPU type, power source/supply, etc.) tasks can be handled by different actors (e.g., computing banks, clusters, hybrid cloud components, etc.) within the training system. Additionally, scheduling module 202 can act as a load balancer between computing resources, when carbon constraints reach a threshold (e.g., 75% - 90% of budgeted carbon footprint). In another example, scheduling module 202 can utilize Ray scheduling architecture to explore new plans for training machine learning models while continuing to optimize training within carbon budgetary constraints.

In an embodiment, scheduling module 202 can prioritize the hyperparameters to be trained and samples to be used in training (i.e., a minibatch). A minibatch can be generated based on its ability to more efficiently train the hyperparameters. Further, scheduling module 202 can dynamically adjust the lost function of the machine learning model based on past trainings of similar machine learning models, (e.g., convolutional neural networks, feed forward neural networks, long short term memory network, transformer networks, etc...).

In another embodiment, scheduling module 202 can sample the machine learning model hyperspace, and consider the overall monetary cost and overall training efficacy in addition to the carbon constraints to determine a Bayesian probability for the hyperparameters that will require tuning due to their effect on the machine learning models accuracy. In an embodiment, scheduling module 202 can utilize prior training runs of similar machine learning models to generate a Bayesian probability of the hyperparameters of the machine learning model to be trained. The Bayesian probability can be the probability of which hyperparameters that will have a greater effect on the accuracy of a machine learning model, or it can be the inverse(i.e., the probability of which hyperparameters that will have little to no effect on the accuracy of the machine learning model).

In another embodiment, scheduling module 202 may use a Bayesian scheduler to generate a cost belief (e.g., carbon required for training) for each hyperparameter and an efficacy belief (e.g., effect of the accuracy of the model by adjusting the hyperparameter) for the hyperparameter. For example, the cost belief for a hyperparameter may be high (e.g., 30% of the carbon budget), but the efficacy belief may be low (e.g., will only have a 0.2% increase in the accuracy of the model). Scheduling module 202 can update the cost belief and the efficacy belief of hyperparameters every n training epochs (e.g., 1, 2,...5).

Carbon estimation module 204 is a computer module that can predict or estimate the carbon footprint of a deep learning model. In an embodiment, carbon tracking module 204 can receive scheduled plan data, computing resource specifications, and carbon constraint data from scheduling module 202 and estimate the carbon footprint of a single training run of a machine learning model (e.g., deep neural network). For example, carbon estimation module 204 can have a deep neural network that can receive inputs including the type of model to be trained, carbon constraints, locations of training, computing components to be used in the training, and the like. Further, carbon estimation module 204 can receive the Bayesian probabilities of the hyperparameters with greatest effect on the accuracy of the machine learning model from scheduling module 202.

Emissions reporter module 206 is a computer module that can monitor the progress of training a machine learning module at the computational node(s) and report the carbon emission to scheduling module 202 for dynamic planning and training of the machine learning model within the carbon budget. Emissions reporter module 206 can have a prebuilt catalog of power usage and electric power sources for some or all of the computing resources in a machine learning model training system. Further, in an embodiment, emissions reporter module 206 can monitor factors that will affect the power consumption of the computing resources (e.g., weather, component age, component material). It should be noted, emissions reporter module 206 can be in constant communication with scheduling module 202 and report the instantaneous carbon utilization to scheduling module 202.

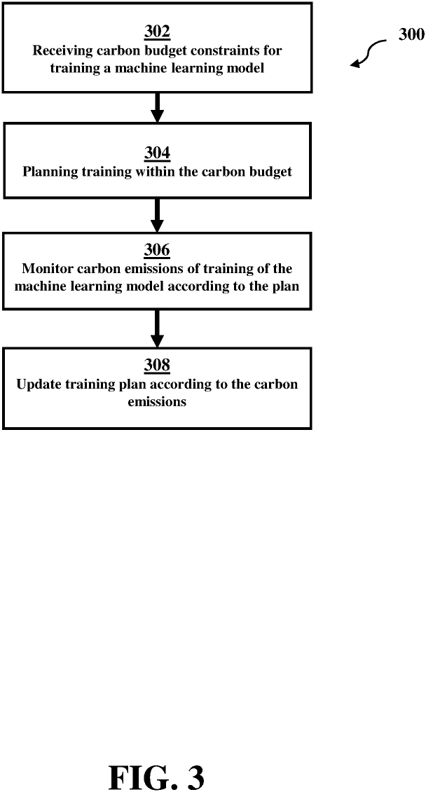

FIG. 3 is a flowchart, generally designated 300, depicting operational steps of a method for carbon bounded machine learning model training system 100. At step 302, scheduling module 202 can receive a carbon budget constraints from a user for training a machine learning model. For example, a user may utilize the user interface at carbon tuner engine 110 to input the carbon budget, type of machine learning model to be trained, and the desired accuracy of the machine learning model.

At step 304, scheduling module 202 can plan the training schedule of the machine learning model based on the carbon budget constraints. For example, scheduling module 202 can sample the hyperparameters of the model to determine which ones will have the greatest effect on the accuracy of the model. Additionally, scheduling module 202 can schedule the computational resources that will be utilized in the training of the model. Scheduling module 202 may consider the power source of the computational resources in the resource scheduling.

Further, at step 304, carbon estimation module 204 can receive the plan generated by scheduling module 202 and estimate the carbon emissions of the plan per iteration of training. Scheduling module 202 can update the plan based on the output of the predicted carbon emissions after the first iteration of training.

At step 306, emissions reporter module 206 can monitor the training of the model, including carbon emissions and the progress of the training. For example, the model can be trained according to the plan generated by scheduling module 202. Emissions monitor can either estimate the carbon emissions or receive real time data of electricity consumption for computing components and the building housing the computing components. It should be noted, while monitoring the training, emissions reporter module 206 can be in constant communication with scheduling module 202 and pause training if the carbon emissions of the training exceed a threshold.

At step 308, scheduling module 202 can update the training plan based on the carbon emissions and associated factors (e.g., weather, computing resource maintenance, etc.). For example, scheduling module 202 can restart the training of specific hyperparameters if training was paused by emissions reporter module 206. In another example, scheduling module 202 can generate minibatches of training data which will increase training of the desired hyperparameters. Further, scheduling module 202 can dynamically update the loss function of the model (i.e., simplify or adjust the constant function) based on the remaining carbon budget and the other factors specified by the user.

FIG. 4 depicts computer system 10, an example computer system representative of a dynamically switching user interface computer 10. Computer system 10 includes communications fabric 12, which provides communications between computer processor(s) 14, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Computer system 10 includes processors 14, cache 22, memory 16, persistent storage 18, network adaptor 28, input/output (I/O) interface(s) 26 and communications fabric 12. Communications fabric 12 provides communications between cache 22, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses or a crossbar switch.

Memory 16 and persistent storage 18 are computer readable storage media. In this embodiment, memory 16 includes random access memory (RAM) 20. In general, memory 16 can include any suitable volatile or non-volatile computer readable storage media. Cache 22 is a fast memory that enhances the performance of processors 14 by holding recently accessed data from memory 16, in close proximity to processors 14. As will be further depicted and described below, memory 16 may include at least one of program module 24 that is configured to carry out the functions of embodiments of the invention.

The program/utility, having at least one program module 24, may be stored in memory 16 by way of example, and not limiting, as well as an operating system, one or more application programs, other program modules, and program data. Each of the operating systems, one or more application programs, other program modules, and program data or some combination thereof, may include an implementation of a networking environment. Program module 24 generally carries out the functions and/or methodologies of embodiments of the invention, as described herein.

Program instructions and data used to practice embodiments of the present invention may be stored in persistent storage 18 and in memory 16 for execution by one or more of the respective processors 14 via cache 22. In an embodiment, persistent storage 18 includes a magnetic hard disk drive. Alternatively, or in addition to a magnetic hard disk drive, persistent storage 18 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Network adaptor 28, in these examples, provides for communications with other data processing systems or devices. In these examples, network adaptor 28 includes one or more network interface cards. Network adaptor 28 may provide communications through the use of either or both physical and wireless communications links. Program instructions and data used to practice embodiments of the present invention may be downloaded to persistent storage 18 through network adaptor 28.

I/O interface(s) 26 allows for input and output of data with other devices that may be connected to each computer system. For example, I/O interface 26 may provide a connection to external devices 30 such as a keyboard, keypad, a touch screen, and/or some other suitable input device. External devices 30 can also include portable computer readable storage media such as, for example, thumb drives, portable optical or magnetic disks, and memory cards. Software and data used to practice embodiments of the present invention can be stored on such portable computer readable storage media and can be loaded onto persistent storage 18 via I/O interface(s) 26. I/O interface(s) 26 also connect to display 32.

Display 32 provides a mechanism to display data to a user and may be, for example, a computer monitor or virtual graphical user interface.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

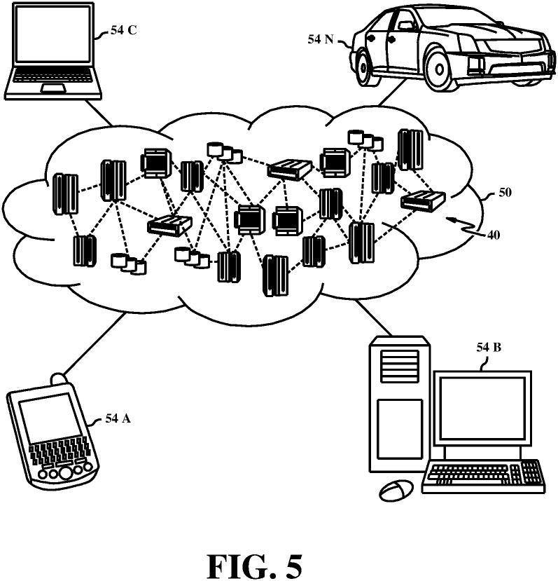

FIG. 5 is a block diagram depicting a cloud computing environment 50 in accordance with at least one embodiment of the present invention. Cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

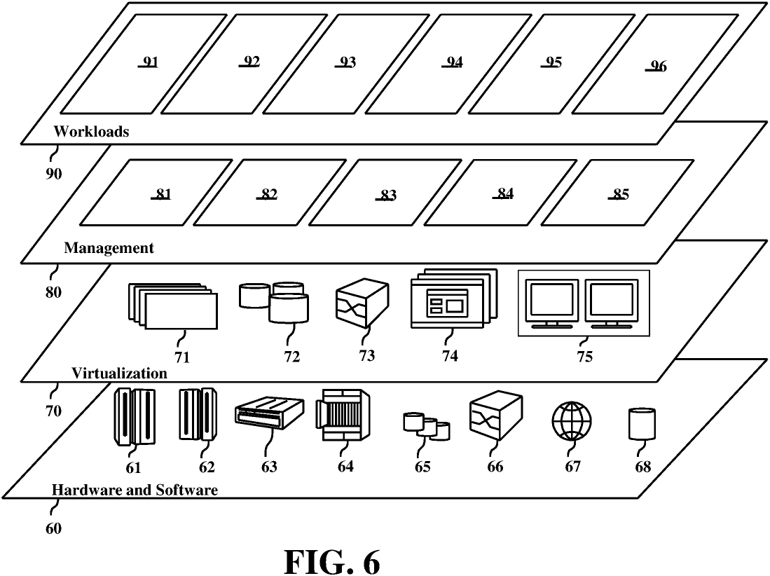

FIG. 6 is a block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and carbon constrained machine learning model training 96.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for training a machine learning model within a carbon budget constraint, the computer-implemented method comprising:
receiving, by a processor, a carbon budget constraint, for training a machine learning model;
generating, by the processor, a training plan for the machine learning model within the carbon budget constraint;
monitoring, by the processor, carbon emissions of the machine learning model training plan; and
update, by the processor, the training plan of the machine learning model based on the monitored carbon emissions.

2. The computer-implemented method of claim 1, wherein generating a training plan further comprises:
sampling, by the processor, a search space of the machine learning model; and
identifying, by the processor, hyperparameters that will have the greatest effect to the accuracy of the machine learning model.

3. The computer-implemented method of claim 2, further comprising:
predicting, by the processor, the carbon emissions of a round of training the identified hyperparameters.

4. The computer-implemented method of claim 1, wherein receiving the carbon budget constraints further comprises:
receiving, by the processor, an architecture type for the machine learning model.

5. The computer-implemented method of claim 4, wherein receiving the carbon budget further comprises:
customizing, by the processor, a single portion of the machine learning model architecture of the machine learning model.

6. The computer-implemented method of claim 5, wherein, one or more specific portions of the single architecture are optimized to operate within a carbon emissions budget, via a model fine tuning customization mode.

7. The computer-implemented method of claim 1, wherein updating the training plan further comprises:
stopping, by the processor, the training of one or more hyperparameters in response to carbon emissions of the training plan exceeding a predetermined threshold.

8. The computer-implemented method of claim 1, wherein updating the training plan further comprises:
tuning, by the processor, the hyper-parameters of the machine learning model to cause the machine learning model to operate within a pre-defined carbon emission performance criteria.

9. The computer-implemented method of claim 1, wherein updating the training plan further comprises:
assigning, by the processor, training of one or more hyperparameters of the machine learning model to a region that utilizes a percentage of one or more renewable power resources above a threshold.

10. The computer-implemented method of claim 2, wherein generating a training plan further comprises:
generating, by the processor, a Bayesian probability for one or more of the identified hyperparameters, wherein the Bayesian probability is the probability training the hyperparameter will have an effect on the accuracy of the machine learning model above a threshold.

11. A computer system for training a machine learning model within a carbon budget constraint, the system comprising:
one or more computer processors;
one or more computer readable storage media; and
computer program instructions to:
receive a carbon budget constraint, for training a machine learning model;
generate a training plan for the machine learning model within the carbon budget constraint;
monitor carbon emissions of the machine learning model training plan; and
update the training plan of the machine learning model based on the monitored carbon emissions.

12. The computer system of claim 11, wherein generating a training plan further comprises instructions to:
sample a search space of the machine learning model; and
identify hyperparameters that will have the greatest effect to the accuracy of the machine learning model.

13. The computer system of claim 12, further comprising instructions to:
predict the carbon emissions of a round of training the identified hyperparameters.

14. The computer system of claim 10, wherein receiving the carbon budget constraints further comprising instructions to:
receive an architecture type for the machine learning model.

15. The computer system of claim 14, wherein receiving the carbon budget further comprises instructions to:
customize a single portion of the machine learning model architecture of the machine learning model.

16. A computer program product for training a machine learning model within a carbon budget constraint, the computer program product comprising one or more computer readable storage media and program instructions sorted on the one or more computer readable storage media to:
receive a carbon budget constraint, for training a machine learning model;
generate a training plan for the machine learning model within the carbon budget constraint;
monitor carbon emissions of the machine learning model training plan; and
update the training plan of the machine learning model based on the monitored carbon emissions.

17. The computer program product of claim 16, wherein generating a training plan further comprises instructions to:
sample a search space of the machine learning model; and
identify hyperparameters that will have the greatest effect to the accuracy of the machine learning model.

18. The computer program product of claim 17, further comprising instructions to:
predict the carbon emissions of a round of training the identified hyperparameters.

19. The computer program product of claim 16, wherein receiving the carbon budget constraints further comprising instructions to:
receive an architecture type for the machine learning model.

20. The computer program product of claim 15, wherein receiving the carbon budget further comprises instructions to:
customize a single portion of the machine learning model architecture of the machine learning model.
